(19) United States
(12) Patent Application Publication
(10) Pub. No.: US 2006/0178133 A1
(43) Pub. Date: Aug. 10, 2006

(54) Portable apparatus for storing a phone book, and method and mobile phone for sending a phone call using the same

(75) Inventor: Seong-Eun Kim, Seongnam-si (KR)

Correspondence Address: DILWORTH & BARRESE, LLP, 333 EARLE OVINGTON BLVD., UNIONDALE, NY, 11553, US

(73) Assignee: SAMSUNG ELECTRONICS CO., LTD., Suwon-si (KR)

(21) Appl. No.: 11/250,282

(22) Filed: Oct. 14, 2005

(30) Foreign Application Priority Data
Feb. 4, 2005 (KR) 10568/2005

(51) Int. Cl. H04L 12/58

(52) U.S. Cl. 455/412.1; 455/414.1

(57) ABSTRACT

A portable apparatus for storing a phone book has a data communication function based on a Synchronization Markup Language (SyncML) protocol and a phone book function. The phone book storage apparatus encodes an outgoing phone number selected by a user from one or more phone numbers contained in the phone book into a SyncML data format including phone call request information. The phone book storage apparatus sends the encoding phone number to a mobile phone through a data communication interface according to the SyncML protocol. The mobile phone has corresponding data communication function based on the SyncML protocol. The mobile phone receives SyncML data including phone call request information and an outgoing phone number from the phone book storage apparatus through the data communication interface based on the SyncML protocol. The mobile phone decodes the SyncML data, and sends a phone call to the outgoing phone number extracted from the decoded data.

### PRIORITY

This application claims priority under 35 U.S.C. § 119 to an application entitled “Portable Apparatus for Storing a Phone Book, and Method and Mobile Phone for Sending a Phone Call Using the Same” filed in the Korean Intellectual Property Office on Feb. 4, 2005 and assigned Ser. No.2005-10568, the contents of which are incorporated herein by reference.

### BACKGROUND OF THE INVENTION

1. Field of the Invention

The present invention generally relates to a mobile phone, and more particularly to a method and apparatus for performing a phone book function in a mobile phone.

2. Description of the Related Art

Conventionally, mobile phones include a phone book function in which users can register phone number information including phone numbers and names associated therewith in a phone book, and can delete, edit, or retrieve the registered information. Mobile phone users can directly register phone numbers in the mobile phone's phone book, and thereafter can retrieve a desired phone number from phone numbers registered in the phone book, identify the retrieved phone number, and send a phone call to the retrieved phone number. Phone book data may be stored and managed in a personal computer (PC), a personal digital assistant (PDA), a web server, etc. through data communication between these devices.

Although mobile phones include many functions to increase user convenience, users may not always capable of using or maximizing the use of these functions because of difficulties using these functions. For example, when a function is complicated to use, usage of the function differ according to user age, ability, etc. For example, if a function is difficult to use, only older and/or more experienced user may use the function.

Although a mobile phone's phone book function is usually the simplest to use from among many various functions included with a mobile phone, many users may not fully understand how to use the phone book function. Moreover, when the users purchase a new mobile phone which is a different model from which the user currently owns, the user must learn to use a new phone book. Due to this inconvenience, the users often save phone numbers using a handwritten notebook, and use the mobile phone only for voice communication functions.

To further complicate matters, when a mobile is inoperable for any reason (e.g., its battery is completely discharged) another phone must be used to conduct a voice communication. In this case, because a user cannot use the phone book which stored in the inoperable mobile phone, the user may be greatly inconvenienced.

When phone book data is managed (e.g., saved, stored, etc.), it can be backed-up using a PC or a web server. However, when either of the PC or the web server are used, a mobile phone must be connected to the PC. When a users current mobile phone is replaced with a another mobile phone, a function for backing up phone book data from the current mobile phone to the new mobile phone can be used. However, when current mobile phone is lost, the function for backing up phone book data cannot be used. Accordingly, there is a problem in that phone numbers registered in the previous mobile phone must be again registered in a mobile phone which replaces the lost mobile phone.

### SUMMARY OF THE INVENTION

It is, therefore, an aspect of the present invention to provide a portable apparatus for storing a phone book, and a method and a mobile phone for sending a phone call using the same through which a user can conveniently use a phone book function, even when the user is unfamiliar with how to use the phone book of the mobile phone.

It is another aspect of the present invention to provide a portable apparatus for storing a phone book, and a method and a mobile phone for sending a phone call using the same through which a user can conveniently make a phone call using a phone book function, even when the user is unfamiliar with how to use the phone book of the mobile phone.

It is another aspect of the present invention to provide a portable apparatus for storing a phone book, and a method and a mobile phone for sending a phone call using the same through which a user can conveniently make a phone call, even when a different type of mobile phone is used.

It is yet another aspect of the present invention to provide a portable apparatus for storing a phone book, and a method and a mobile phone for sending a phone call using the same that can back up the phone book without using a personal computer (PC) or server.

The above and other aspects of the present invention can be achieved by a portable apparatus for storing a phone book. The portable apparatus includes a memory for storing a phone number database; a data communication interface for providing a data communication function with a mobile phone, the mobile phone having a data communication function based on a Synchronization Markup Language (SyncML) protocol; a key input unit for inputting a key; and a controller for encoding an outgoing phone number selected by a user from phone numbers of the phone book into a SyncML data format, and sending a result of the encoding to the mobile phone through the data communication interface according to the SyncML protocol, the SyncML data format including phone call request information.

The above and other aspects of the present invention can also be achieved by a method for supporting a calling operation of a mobile phone in a portable phone book storage apparatus having a data communication function based on a Synchronization Markup Language (SyncML) protocol and a phone book function, the mobile phone having the data communication function based on the SyncML protocol. The method including encoding an outgoing phone number selected by the mobile phone's user from phone numbers contained in a phone book into a SyncML data format including phone call request information and sending the encoded phone number data to the mobile phone according to the SyncML protocol.

The above and other aspects of the present invention can also be achieved by a mobile phone. The mobile phone including a data communication interface for providing a data communication function with a portable phone book storage apparatus, the portable phone book storage apparatus having a data communication function based on a Synchronization Markup Language (SyncML) protocol and a phone book function; and a controller for receiving SyncML data including phone call request information and an outgoing phone number from the portable phone book storage apparatus through the data communication interface based on the SyncML protocol, decoding the SyncML data, and sending a phone call to the outgoing phone number extracted from the decoded data.

The above and other aspects of the present invention can also be achieved by a method for sending a phone call in a mobile phone having a data communication function based on a Synchronization Markup Language (SyncML) protocol. The method including receiving SyncML data including phone call request information and an outgoing phone number from a portable phone book storage apparatus, the portable phone book storage apparatus having the data communication function based on the SyncML protocol and a phone book function; and decoding the SyncML data, and sending a phone call to the outgoing phone number extracted from the decoded data.

### BRIEF DESCRIPTION OF THE DRAWINGS

The above and other aspects and advantages of the present invention will be more clearly understood from the following detailed description taken in conjunction with the accompanying drawings, in which:

FIG. 1 is a block diagram illustrating a connection state between a portable phone book storage apparatus and a mobile phone in accordance with an embodiment of the present invention;

FIG. 2 is a block diagram illustrating the mobile phone in accordance with an embodiment of the present invention;

FIG. 3 is a block diagram illustrating the portable phone book storage apparatus in accordance with an embodiment of the present invention;

FIG. 4 is a diagram illustrating protocol layer structures of the mobile phone and the portable phone book storage apparatus in accordance with an embodiment of the present invention;

FIG. 5 is a diagram illustrating the format of phone number data in accordance with an embodiment of the present invention;

FIG. 6 is a flow chart illustrating a process for processing phone book data for sending an outgoing phone call in the portable phone book storage apparatus in accordance with an embodiment of the present invention;

FIG. 7 is a flow chart illustrating a process for performing phone book data synchronization in the portable phone book storage apparatus in accordance with an embodiment of the present invention; and

FIG. 8 is a flow chart illustrating a process for sending an outgoing phone call or performing phone book data synchronization in the mobile phone in accordance with an embodiment of the present invention.

### DETAILED DESCRIPTION OF THE PREFERRED EMBODIMENTS

Preferred embodiments of the present invention will be described in detail herein below with reference to the accompanying drawings. In the following description, a detailed description of known functions and configurations incorporated herein will be omitted for conciseness.

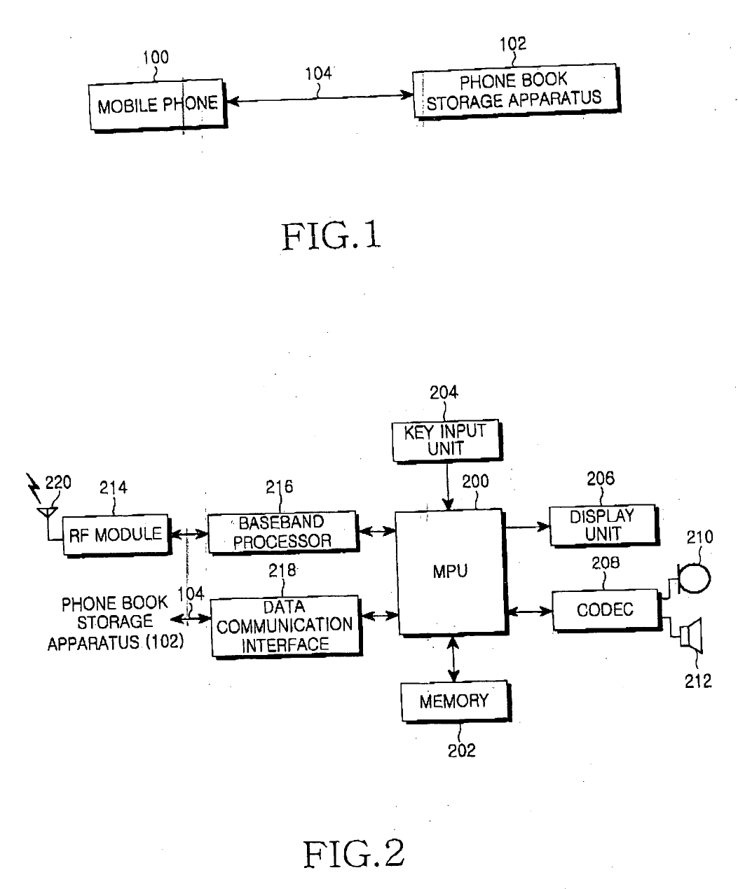

FIG. 1 is a block diagram illustrating a connection state between a portable phone book storage apparatus and a mobile phone in accordance with an embodiment of the present invention. The mobile phone 100 and the portable phone book storage apparatus 102 support a phone book function for registering, deleting, editing, or retrieving a phone number, and a Synchronization Markup Language (SyncML) protocol of a data synchronization technology in a mobile communication environment. The mobile phone 100 and the phone book storage apparatus 102 perform a data communication function based on the SyncML protocol. For example, an interface 104 can use wired data communication through a data cable connected to a data communication connector of the mobile phone 100, or can use a wireless data communication technology such a Bluetooth wireless technology.

FIG. 2 is a block diagram illustrating the mobile phone 100 in accordance with an embodiment of the present invention. A microprocessor unit (MPU) 200 serving as a controller in the mobile phone 100 interworks with the phone book storage apparatus 102 through a data communication interface 218. The MPU 200 performs various functions of the mobile phone 100 for a phone call, data communication, wireless Internet access, and others, and processes and controls phone data synchronization and an outgoing phone call while interworking with the phone book storage apparatus 102 in accordance with an embodiment of the present invention.

A memory 202 stores one or more programs for processing and controlling operations of the MPU 200, and stores reference data and various data including a phone book capable of being updated. The memory 202 serves as a working memory of the MPU 200. A key input unit 204 includes numeric keys, * and # keys, and function keys, and provides the MPU 200 with key input data corresponding to a key pressed by a user. A display unit 206 displays received images, stored images of the memory 202, and various images of operation information provided from the MPU 200 on a screen according to a control operation of the MPU 200. A coder-decoder (CODEC) 208 connected to the MPU 200, and a microphone 210 and a speaker 212 connected to the CODEC 208 are voice input/output units used for a phone call and/or a voice recording.

A radio frequency (RF) module 214 transmits an RF signal to and receives an RF signal from a mobile communication base station (not shown). A baseband processor 216 receives a transmission on a signal output from the MPU 200 and modulates the transmission signal and outputs it to the RF Module 214. The RF module 214 modulates the transmission signal output from the baseband processor 216 and transmits a corresponding RF signal through an antenna. The RF module 214 demodulates the RF signal received through the antenna and supplies the demodulated RF signal to the MPU 200. The baseband processor 216 processes a baseband signal transmitted or received between the RF module 214 and the MPU 200. The data communication interface 218 provides a data communication function based on the SyncML protocol through the interface 104 between the MPU 200 and the phone book storage apparatus 102.

In the mobile phone 100, the MPU 200 receives SyncML data including phone call request information and an outgoing phone number through the data communication interface 218 based on the SyncML protocol. The MPU 200 decodes the SyncML data, and sends a phone call to the outgoing phone number extracted from the decoded data.

The MPU 200 receives and decodes SyncML data including phone numbers of a phone book from the phone book storage apparatus 102 through the data communication interface 218 based on the SyncML protocol. The MPU 200 registers the phone numbers extracted from the decoded data in the phone book of the memory 202 of the mobile phone 100. The MPU 200 sends, to the phone book storage apparatus 102, one or more phone numbers which are not registered in the phone book storage apparatus 102, from among one or more phone numbers which are registered in the phone book of the mobile phone 100 according to data synchronization based on the SyncML protocol. The sent phone number is registered in the phone book of the portable phone book storage apparatus 102.

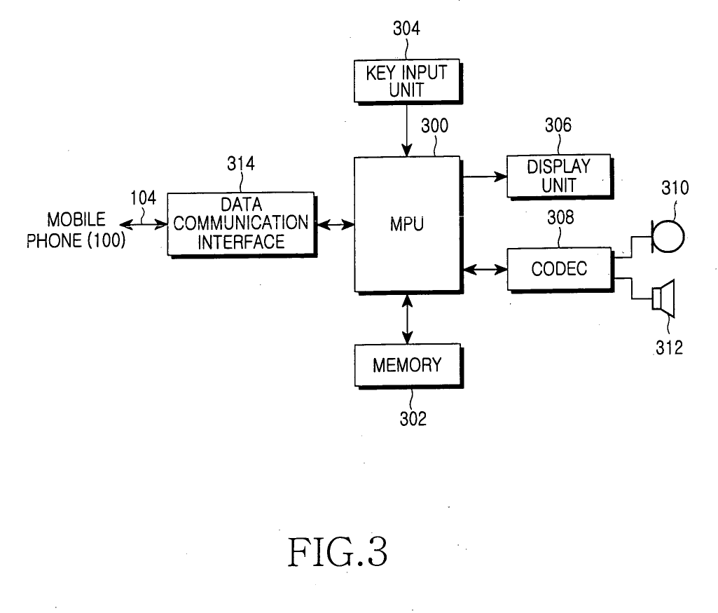

FIG. 3 is a block diagram illustrating the portable phone book storage apparatus 102 in accordance with an embodiment of the present invention. An MPU 300 serving as a controller performs a phone book function according to a key input through a key input unit 304, and processes and controls phone book data synchronization and an outgoing phone call while interworking with the mobile phone 100.

A memory 302 stores a program for performing a process and control operations of the MPU 300, and stores reference data and various data including a phone book capable of being updated. The memory 302 serves as a working memory of the MPU 300. A key input unit 304 includes numeric keys, * and # keys, and function keys for a phone book function, a phone call, and a data request of the user for data synchronization. The key input unit 304 provides the MPU 300 with key input data corresponding to a key pressed by the user. The phone book key, the phone call key, or the data request key for data synchronization may use a menu-based key or a separate dedicated key in the as is conventionally used. A display unit 306 displays phone number information according to a control operation of the MPU 300. A CODEC 308 connected to the MPU 300, and a microphone 310 and a speaker 312 connected to the CODEC 308 are voice input/output units used for phone number information output and voice recording.

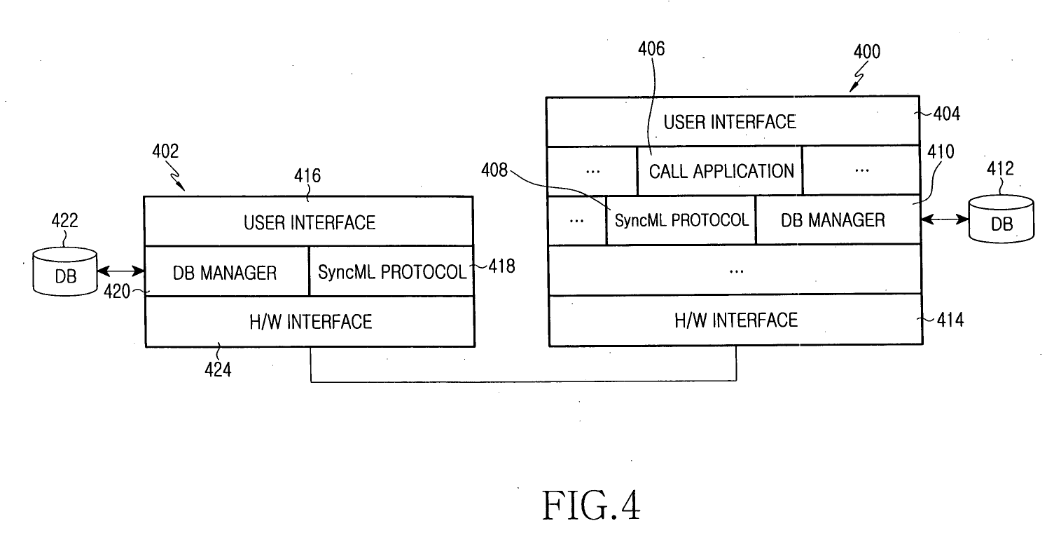

FIG. 4 is a diagram illustrating a protocol layer structure for sending an outgoing phone call and performing data synchronization based on interworking between the mobile phone 100 and the phone book storage apparatus 102 in accordance with an embodiment of the present invention. In FIG. 4, reference numeral 400 denotes a protocol layer structure of the mobile phone 100. The protocol layer structure 400 includes a user interface 404 and various applications (not illustrated), and is for the most part basically the same as protocol layer structures used by conventional mobile phones.

The protocol layer structure 400 further includes a SyncML protocol entity 408 for interworking with the phone book storage apparatus 102. The SyncML protocol entity 408 sends an outgoing phone number from the phone book storage apparatus 102 to a call application 406 such that an outgoing phone call can be sent. The SyncML protocol entity 408 allows SyncML protocol-based data synchronization to be performed between a phone book database (DB) 412 of the mobile phone 100 and a phone book DB 422 of the phone book storage apparatus 102 through a DB manager 410. The DB manager 410 controls operations for registering, deleting, editing, and retrieving data in a phone book of the DB 412. A hardware (H/W) interface 414 of the mobile phone 100 is coupled to an H/W interface 424 of the phone book storage apparatus 102.

In FIG. 4, reference numeral 402 denotes a protocol layer structure of the phone book storage apparatus 102. The protocol layer structure 402 includes a user interface 416. The protocol layer structure 402 further includes a SyncML protocol entity 418 for interworking with the mobile phone 100. The SyncML protocol entity 418 sends an outgoing phone number selected by the user to the mobile phone 100. The SyncML protocol entity 418 allows SyncML protocol-based data synchronization to be performed between the phone book DB 412 of the mobile phone 100 and the phone book DB 422 of the phone book storage apparatus 102 through a DB manager 420. The DB manager 420 manages registration, deletion, editing, and retrieval in a phone book of the DB 422. An H/W interface 424 of the phone book storage apparatus 102 is coupled to the H/W interface 414 of the mobile phone 100.

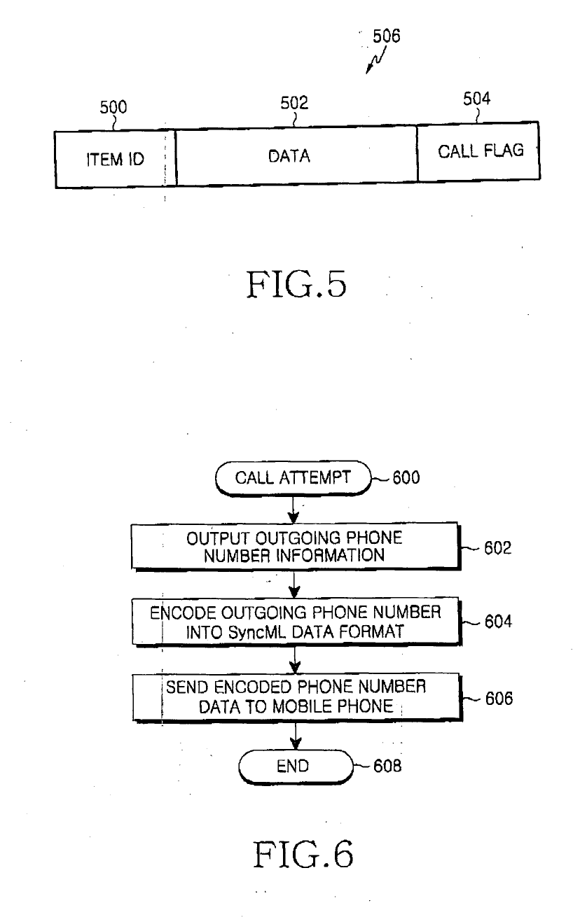

FIG. 5 illustrates a phone number data format 506 for a phone call and data synchronization according to interworking between the mobile phone 100 and the phone book storage apparatus 102 in accordance with an embodiment of the present invention. The phone number data format 506 includes an item identifier (ID) field 500, a data field 502, and a call flag field 504.

An index of a phone number to be sent to the mobile phone 100 is inserted into the item ID field 500. Phone number data to be sent to the mobile phone 100 is inserted into the data field 502. The call flag field 504 is added to a conventional SyncML data format in accordance with the embodiment of the present invention and includes a call flag. The call flag indicates if a phone call request is present. If a phone call request is present, the call flag inserted into the call flag field 504 has a value of “True”. However, if a phone call request is not present, i.e., if the message is used for SyncML data synchronization between the mobile phone 100 and the phone book storage apparatus 102, the call flag inserted into the call flag field 504 has a value of “False”.

For reference, the format of phone number data stored in the DB 422 of the phone number storage apparatus 102, is illustrated in Example 1. The format of SyncML data sent from the phone book storage apparatus 102 to the mobile phone 100 is illustrated in Example 2.

### EXAMPLE 1

```
  BEGIN:VCARD
  VERSION:2.1
  FN:James Dean
  N:James; Dean
TEL;WORK;VOICE:+1-919-555-1234
TEL;WORK;FAX:+1-919-555-9876
  NOTE: This is phone number.
END:VCARD
```

### EXAMPLE 2

```
<SyncML xmlns = ‘SYNCML:SYNCML’>
  <SyncHdr> ............</SyncHdr>
  <SyncBody>
    <Add>
      <CmdID>15</CmdID>
      <Meta>
      <Type>text/x-vcard</Type>
      <size>3000</size>
      </Meta>
      <Item>
      <Source><LocURI>2</LocURI></Source>
      <Data>
      BEGIN:VCARD
      VERSION:2.1
      FN:James Dean
      N:James;Dean
      TEL;WORK;VOICE:+1-919-555-1234
      TEL;WORK;FAX:+1-919-555-9876
      NOTE: This is phone number.
      END:VCARD
      </Data>
      <CallFlag> TRUE </CallFlag>
      <MoreData/>
      </Item>
  </Add>
</SyncBody>
    </SyncML>
```

In Example 2, “<CallFlag>TRUE</CallFlag>” is an additional SyncML field, i.e., the call flag field 504 of FIG. 5, in accordance with an embodiment of the present invention.

FIG. 6 is a flow chart illustrating a process for processing phone book data for sending an outgoing phone call in the phone book storage apparatus 102 in accordance with an embodiment of the present invention. An example in which the mobile phone 100 sends a phone call using the phone book storage apparatus 102 will be described with reference to FIG. 6. When the user retrieves a desired outgoing phone number from the phone book of the DB 422 of the phone number storage apparatus 102 using the key input unit 304 or attempts to make a phone call by inputting a shortcut key of the key input unit 304 associated with a desired outgoing phone number in step 600, the MPU 300 executes step 602 in response to the outgoing call attempt of the user. In step 602, outgoing phone number information is output from the phone number storage apparatus 102. In this case, a registered name mapped to the outgoing phone number, for example, “My Home”, is displayed on the display unit 306, and simultaneously a voice sound of “My Home” is output through the speaker 310.

In step 604, the outgoing phone number is encoded into the SyncML data format for the outgoing phone call. In step 606, the encoded phone number data is sent to the mobile phone 100 through the data communication interface 314 according to the SyncML protocol. In step 608, the process for the outgoing phone call ends. The SyncML data format for the outgoing phone call includes the call flag field 504 into which the call request information having the “True” value has been inserted as illustrated in FIG. 5 and Example 2. This SyncML data format is shown in more detail in Table 1.

TABLE 1

| Item ID | Data | Call Flag |
|---|---|---|
| 1 | My Home 02-111-2222 | True |

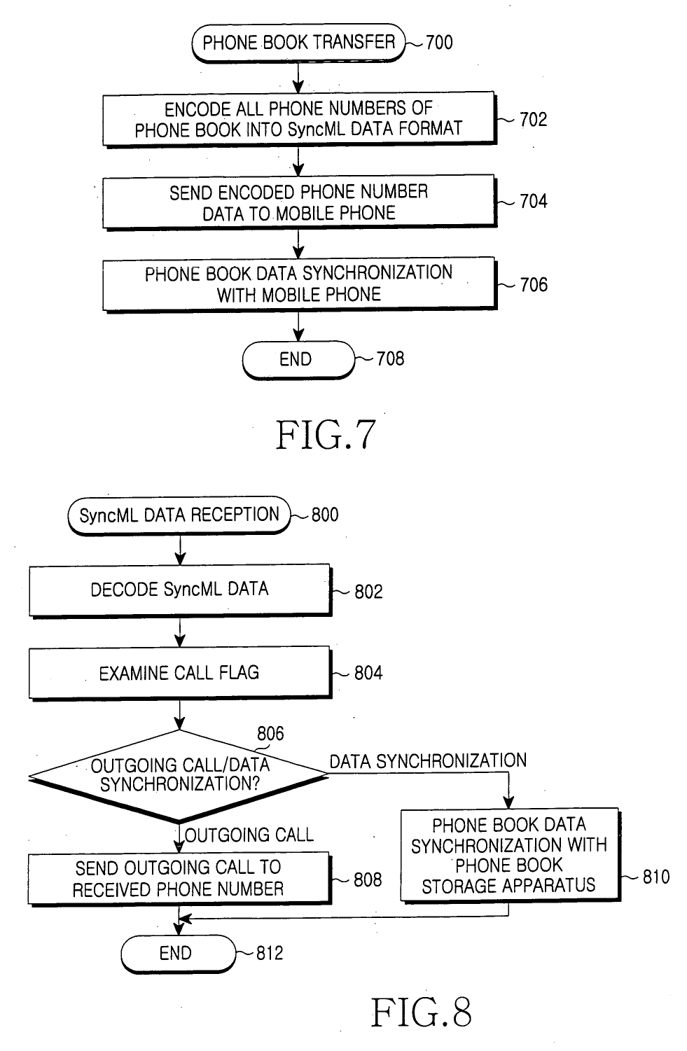

FIG. 7 is a flow chart illustrating a process for performing phone book data synchronization with the mobile phone 100 in the phone book storage apparatus 102 in accordance with an embodiment of the present invention. An example of the phone book data synchronization between the mobile phone 100 and the phone book storage apparatus 102 will be described with reference to FIG. 7. When the user requests a phone book transfer through the key input unit 304 in step 700, the MPU 300 executes step 702 in response to the phone book transfer request.

In step 702, the MPU 300 encodes all phone numbers of the phone book stored in the DB 422 into the SyncML data format for data synchronization. In step 704, the MPU 300 sends the encoded phone number data to the mobile phone 100 through the data communication interface 314 based on the SyncML protocol. In step 706, phone book data synchronization with the mobile phone 100 is performed according to the SyncML protocol. In step 708, the phone book data synchronization based on the SyncML protocol ends. The SyncML data format for the data synchronization includes the “False” value inserted into the call flag field 504. This SyncML data format is shown in Table 2. Since phone book data synchronization is gone through the same process as SyncML data synchronization, a general SyncML data format excluding the call flag field 504 can be used.

TABLE 2

| Item ID | Data | Call Flag |
|---|---|---|
| 1 | My Home 02-111-2222 | False |
| 2 | First 011-111-1111 | False |
| . . . | . . . | False |
| 3 | Second 011-333-3333 | False |

FIG. 8 is a flow chart illustrating a process for sending an outgoing phone call, or performing phone book data synchronization in the mobile phone 100 in accordance with an embodiment of the present invention. When the MPU 200 of the mobile phone 100 receives SyncML data based on the SyncML protocol from the phone book storage apparatus 102 through the data communication interface 218 in step 800, it decodes the SyncML data in step 802.

In step 804, the MPU 200 examines the call flag inserted into the call flag field 504 as illustrated in FIG. 5. In step 806, the MPU 200 determines if a value of the call flag is associated with an outgoing phone call or data synchronization. If the call flag is a “True” value, it is determined that an outgoing phone call request through the phone book storage apparatus 102 is present. Then, the MPU 200 sends an outgoing phone call to a received outgoing phone number, i.e., a decoded phone number extracted from the SyncML data, in step 808. A process according to the SyncML data reception ends in step 812.

However, if the call flag is a “False” value, it is determined that the call flag is associated with phone book data synchronization with the phone book storage apparatus 102. In step 810, the MPU 200 performs the phone book data synchronization with the phone book storage apparatus 102 according to the SyncML protocol. In step 812, the MPU 200 ends a process according to SyncML data reception. In this case, phone numbers decoded from the received SyncML data are registered in the phone book stored in the DB 412 of the mobile phone 100. A phone number not registered in the phone book stored in the DB 422 of the phone book storage apparatus 102 from among the phone numbers registered in the phone book stored in the DB 412 of the mobile phone 100 is sent to the phone book storage apparatus 102 through the data communication interface 218 according to the data synchronization based on the SyncML protocol. Then, the sent phone number is registered in the phone book of the phone book storage apparatus 102.

The above-described data synchronization process is the same as data synchronization between a SyncML server and client. Detailed content is defined in the data synchronization specification according to the Open Mobile Alliance (OMA).

According to the data synchronization specification, the synchronization process performed in steps 706 and 810 is referred to as slow synchronization. When the phone book storage apparatus 102 sends all phone number data of its own phone book through the slow synchronization, the MPU 200 of the mobile phone 100 compares its own phone number data with the sent (i.e., received) phone number data on a field-by-field basis. The MPU 200 sends corrected content to the phone book storage apparatus 102. That is, a phone number not registered in the phone book of the phone book storage apparatus 102 from among the phone numbers registered in the phone book of the mobile phone 100 is sent to the phone book storage apparatus 102. Also, a phone number not stored in the phone book of the mobile phone 100 is additionally registered in the phone book if the mobile phone 100 on the basis of the corrected content. A synchronization process is performed which compares and matches information of previously stored phone numbers.

The phone book storage apparatus 102 receives corrected content from the mobile phone 100 according to data synchronization based on the SyncML protocol in step 810. Then, a phone number not registered in the phone book of the phone book storage apparatus 102 from among the phone numbers registered in the phone book of the mobile phone 100 is registered in the phone book of the phone book storage apparatus 102 in step 706.

After a user learns to use a phone book storage apparatus, even when different types of mobile phones with different phone book functions are used, the user can conveniently make a phone call using a standardized phone book function. Accordingly, if the user uses the phone book storage apparatus even when making a phone call using a mobile phone of another person, the user can conveniently make the phone call using a phone number registered in the phone book of the phone book storage apparatus.

A phone book can be conveniently backed up as data synchronization is performed between a portable phone book storage apparatus and a mobile phone. Moreover, the present invention can overcome the difficulty of backing up the phone book through a personal computer (PC) or web server. Even when a new mobile phone is used due to the loss of an existing mobile phone, a phone book can be conveniently backed up or installed in the new mobile phone using the portable phone book storage apparatus. Accordingly, the user does not need to manually enter phone numbers into a phone book of the new mobile phone.

Although preferred embodiments of the present invention have been disclosed for illustrative purposes, those skilled in the art will appreciate that various modifications, additions, and substitutions are possible, without departing from the scope of the present invention. Therefore, the present invention is not limited to the above-described embodiments, but is defined by the following claims, along with their full scope of equivalents.

What is claimed is:

1 . A portable apparatus for storing a phone book, comprising:
a memory for storing a phone number database;
a data communication interface for providing a data communication function with a mobile phone, the mobile phone having a data communication function based on a Synchronization Markup Language (SyncML) protocol;
a key input unit for inputting a key; and
a controller for encoding an outgoing phone number, selected by a user from one or more phone numbers contained in the phone book, into a SyncML data format including a call request information, and sending a result of the encoding to the mobile phone through the data communication interface according to the SyncML protocol.

2. The portable apparatus of claim 1, wherein the SyncML data format includes a call flag field into which the call request information is inserted.

3. The portable apparatus of claim 1, wherein the controller encodes one or more phone numbers contained in the phone book into the SyncML data format in response to a user's phone book transfer request through the key input unit, and sends a result of the encoding to the mobile phone through the data communication interface according to the SyncML protocol, such that the one or more phone numbers contained in the phone book of the portable apparatus can be registered in a phone book of the mobile phone.

4. The portable apparatus of claim 3, wherein the controller:
receives a phone number which is not registered in the phone book of the portable apparatus said phone number being sent according to data synchronization based on the SyncML protocol; and
registers the received phone number in the phone book of the portable apparatus.

5. The portable apparatus of claim 1, wherein the controller performs a phone book function for registering, deleting, editing, or retrieving a phone number of the phone book in response to a key input through the key input unit.

6. The portable apparatus of claim 2, wherein the controller performs a phone book function for registering, deleting, editing, or retrieving a phone number of the phone book in response to a key input through the key input unit.

7. The portable apparatus of claim 3, wherein the controller performs a phone book function for registering, deleting, editing, or retrieving a phone number of the phone book in response to a key input through the key input unit.

8. The portable apparatus of claim 4, wherein the controller performs a phone book function for registering, deleting, editing, or retrieving a phone number of the phone book in response to a key input through the key input unit.

9. The portable apparatus of claim 5, further comprising:
a display unit, controlled by the controller, for displaying information of the phone book function performed by the controller.

10. The portable apparatus of claim 5, further comprising:
at least one of a voice input unit for inputting an audible signal and a voice output unit for outputting an audible signal according to the phone book function performed by the controller.

11. A method for supporting a calling operation of a mobile phone in a portable phone book storage apparatus having a data communication function based on a Synchronization Markup Language (SyncML) protocol and a phone book function, the mobile phone having the data communication function based on the SyncML protocol, comprising the steps of:
encoding, by the portable phone book storage apparatus including a phone book, an outgoing phone number selected by a user from one or more phone numbers contained in the phone book into a SyncML data format including call request information; and
sending encoded phone number data to the mobile phone according to the SyncML protocol.

12. The method of claim 11, wherein the SyncML data format includes a call flag field into which the call request information is inserted.

13. The method of claim 11, further comprising the steps of:
encoding the one or more phone numbers into the SyncML data format in response to a user's phone book transfer request such that the phone numbers can be registered in a phone book of the mobile phone; and
sending encoded phone number data to the mobile phone according to the SyncML protocol.

14. The method of claim 13, further comprising the steps of:
receiving, from the mobile phone, a phone number not registered in the phone book of the portable phone book storage apparatus from among the phone numbers contained in the phone book of the mobile phone according to data synchronization based on the SyncML protocol; and
registering the received phone number in the phone book of the portable phone book storage apparatus.

15. A mobile phone, comprising:
a data communication interface for providing a data communication function with a portable phone book storage apparatus, the portable phone book storage apparatus having a data communication function based on a Synchronization Markup Language (SyncML) protocol and a phone book function; and
a controller for receiving SyncML data including call request information and an outgoing phone number from the portable phone book storage apparatus through the data communication interface based on the SyncML protocol, decoding the SyncML data, and sending a phone call to the outgoing phone number extracted from the decoded data.

16. The mobile phone of claim 15, wherein the SyncML data includes a call flag field into which the call request information is inserted by the portable phone book storage apparatus.

17. The mobile phone of claim 15, wherein the controller receives, from the portable phone book storage apparatus, SyncML data including one or more phone numbers contained in a phone book stored in the portable phone book storage apparatus through the data communication interface based on the SyncML protocol, decodes the SyncML data, and registers the phone numbers extracted from the decoded data in a phone book of the mobile phone.

18. The mobile phone of claim 17, wherein the controller sends, to the portable phone book storage apparatus, a phone number which is not registered in the portable phone book storage apparatus according to data synchronization based on the SyncML protocol such that the phone number which is not registered in the portable phone book storage apparatus can be registered in the phone book of the portable phone book storage apparatus.

19. A method for sending a phone call in a mobile phone having a data communication function based on a Synchronization Markup Language (SyncML) protocol, comprising the steps of:
receiving SyncML data including call request information and an outgoing phone number from a portable phone book storage apparatus, the portable phone book storage apparatus having the data communication function based on the SyncML protocol and a phone book function; and
decoding the SyncML data, and sending a phone call to the outgoing phone number extracted from the decoded data.

20. The method of claim 19, wherein the SyncML data includes a call flag field into which the call request information is inserted by the portable phone book storage apparatus.

21. The method of claim 19, further comprising the steps of:
receiving, from the portable phone book storage apparatus, SyncML data including one or more phone numbers contained in a phone book stored in the portable phone book storage apparatus according to the SyncML protocol;
decoding the one or more phone numbers of the phone book of the portable phone book storage apparatus from the received SyncML data; and
registering the one or more phone numbers in a phone book of the mobile phone.

22. The method of claim 21, further comprising the steps of:
sending, to the portable phone book storage apparatus, a phone number which is not registered in the portable phone book storage apparatus according to data synchronization based on the SyncML protocol; and
registering the sent phone number in the phone book of the portable phone book storage apparatus.
